(19) United States
(12) Patent Application Publication
(10) Pub. No.: US 2004/0049559 A1
(43) Pub. Date: Mar. 11, 2004

(54) Data broadcasting system and a receiver for one such system

(76) Inventor: Jacques Saubade, Bordeaux Cauderan (FR)

Correspondence Address: YOUNG & THOMPSON, 745 SOUTH 23RD STREET 2ND FLOOR, ARLINGTON, VA, 22202

(21) Appl. No.: 10/451,983

(22) PCT Filed: Feb. 25, 2002
(86) PCT No.: PCT/FR02/00679

(30) Foreign Application Priority Data
Mar. 26, 2001 (FR) 01/03997

(51) Int. Cl. G06F 15/16

(52) U.S. Cl. 709/219

(57) ABSTRACT

A system for broadcasting data, which are periodically updated, to intelligent terminals (T1, T2, T3) comprises a display screen (E1, E2, E3) which can be put on standby automatically during periods of reduced activity of the terminal, which remains powered up. The system comprises, for each terminal, an FM receiver (K) which is provided to capture the data transmitted on an FM radio transmitter subcarrier, the receiver (K) comprising a connector that is used to link to a peripheral connector of the terminal. A software program is installed in the terminal (T1, T2, T3) in order to process the data captured by the receiver (K). The assembly is used to ensure that the data captured are displayed on the screen when the terminal is on standby. Moreover, the data are stored in memory elements in the terminal and can be retrieved for display.

The invention pertains to a system for broadcasting periodically updated data to intelligent terminals comprising memory means, data processing means, means of connection with peripherals, and a display screen which can be placed on standby automatically in the course of periods of reduced activity of the terminal which remains powered up.

In practice, it is found that the screens of intelligent terminals, in particular the screens of PC type personal computers, are in standby mode for a good part of the time. Statistics estimate the screen standby periods at more than 40% of the time. The number of PCs installed in France is currently of the order of 13 million units, 9 million of which are in companies.

It is a pity not to benefit further from this hardware during the standby periods.

There exists, moreover, a need to disseminate information in numerous fields, for example those of economics, advertising, local life, road traffic, the weather, etc.

Dissemination on a paper medium is relatively expensive and does not take place in real time. Broadcasting by radiophonic or televized announcement is fleeting and likewise expensive. Furthermore, the audience for these media is tending to stabilize or even decrease with the transferring of part of the time earmarked for television to Internet activity.

It would be advantageous, furthermore, to be able to target and segment the broadcast information, for example as a function of socio-professional groups of consumers or as a function of their geographical location.

The broadcasting system would have to be inexpensive and not require large investments. Its use would have to be simple and fast to assimilate.

To satisfy these demands, according to the invention, the system for broadcasting periodically updated data to intelligent terminals comprising memory means, data processing means, means of connection with peripherals, and a display screen which can be placed on standby automatically in the course of periods of reduced activity of the terminal which remains powered up, is characterized in that it comprises an FM receiver designed to capture data transmitted on an FM radio transmitter subcarrier, this receiver comprising a connector for linking to a peripheral socket of the terminal, and in that software is installed in the terminal for utilizing the data captured by the receiver, the assembly being designed to ensure the displaying of the captured data on the screen when it is on standby, these data moreover being stored in memory means of the terminal and being retrievable for display.

The system comprises a server which dispatches data originating from a provider to the FM transmitter. Advantageously, the subcarrier used is the 76 kHz DARC subcarrier. For the dispatching of the data on the DARC subcarrier, a DARC encoder is placed alongside the FM transmitter for adding the data to the multiplexed FM signal. The data are dispatched simultaneously with the multiplexed audio signal.

Each intelligent terminal is advantageously a personal computer, in particular of the PC type.

The data being provided by radio, there is absolutely no need to connect the terminal to a cabled network in order to retrieve them.

The FM transmitters already installed have the DARC subcarrier which merely needs to be coded for the broadcasting of the data.

The broadcast data can be encrypted in such as way as to be utilizable only by an FM receiver comprising the decryption key. It is thus possible to target the people for which the data are intended.

Advantageously, the data dispatched by FM channel are designed to make it possible to establish a link with a site on a cabled network in respect of more detailed information concerning the data broadcast, access to the site being ensured by connection of the terminal to the network. This network is advantageously the Internet network.

Preferably, the data are dispatched in the form of pages in the HTML format.

Apart from a personal computer, the intelligent terminal can be a portable computer, or a public Internet outlet allowing connection to the Internet network.

Advantageously, the means of connection of the FM receiver to the terminal consists of a plug for USB socket of the terminal, and the powering up of the FM receiver is ensured by the USB socket from the terminal.

Preferably, the FM receiver comprises processing means having limited capability for performing only a part of the processing of the data received, and the other part of the processing of the data is ensured by the intelligent terminal in which software for operating the receiver has been installed. The cost price of the FM receiver is thereby decreased.

The FM receiver can be constructed with an especially reduced footprint, the dimensions possibly being less than 90×50×20 mm and the weight possibly being less than 40 g.

In the case of broadcasting on DARC subcarrier, the FM receiver performs the processing corresponding to the first two physical layers alone, while the intelligent terminal performs the processing corresponding to the subsequent physical layers.

The dispatching of the data between the transmitter and the receiver can be performed at a speed of 16 Kbits/s.

The addressing of the data to a segment of users is ensured by a message coded on transmission, in conjunction with the decoder of the receiver.

The images dispatched and gathered can be moving images.

The invention also relates to an FM receiver for data broadcasting system as defined above, this receiver comprising a plug for connecting to a peripheral socket of an intelligent terminal. Preferably, the plug is designed for connection to a USB socket of the terminal.

When the data are dispatched on DARC subcarrier, the FM receiver is advantageously designed to process only the first two physical layers. The receiver can thus be particularly economical and compact.

The invention consists, aside from the arrangements set forth hereinabove, of a certain number of other arrangements which will be dealt with more explicitly hereinafter with regard to an exemplary embodiment described with reference to the appended drawings, but which is in no way limiting.

In these drawings:

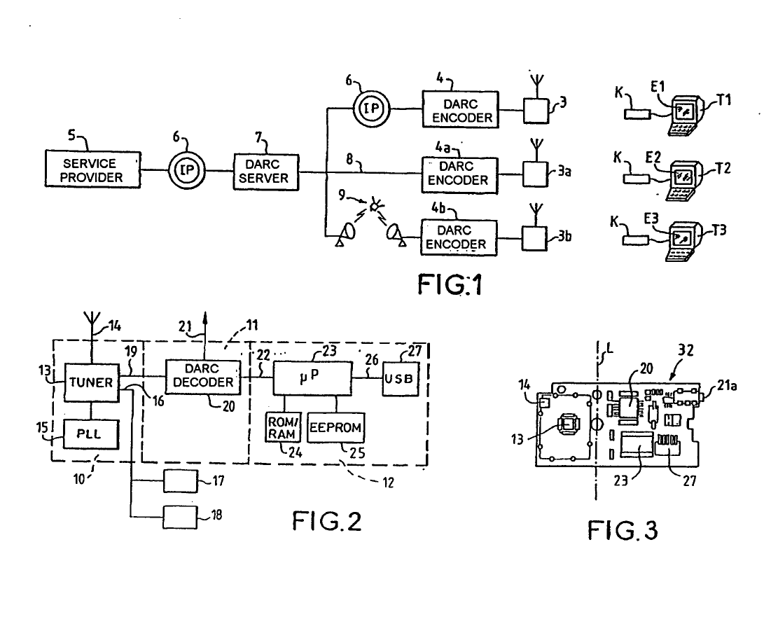

FIG. 1 is a diagram of a broadcasting system according to the invention.

FIG. 2 is a block diagram of the FM receiver according to the invention.

FIG. 3 is a diagram of the card of the FM receiver.

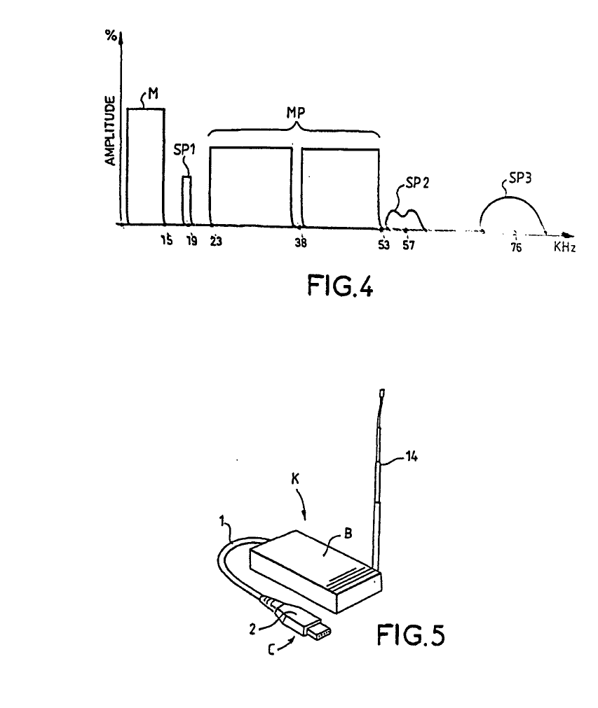

FIG. 4 is a schematic of an FM transmission with the frequency plotted along the abscissa and the amplitude plotted along the ordinate.

FIG. 5 is a perspective view of a receiver according to the invention.

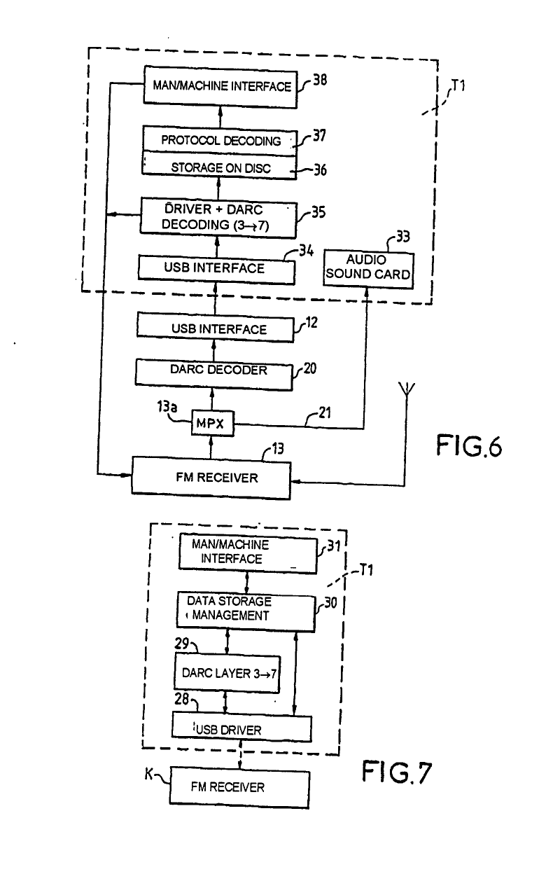

FIG. 6 is a diagram of the structure of the receiver.

FIG. 7 is another diagram of the processing of the data in the terminal.

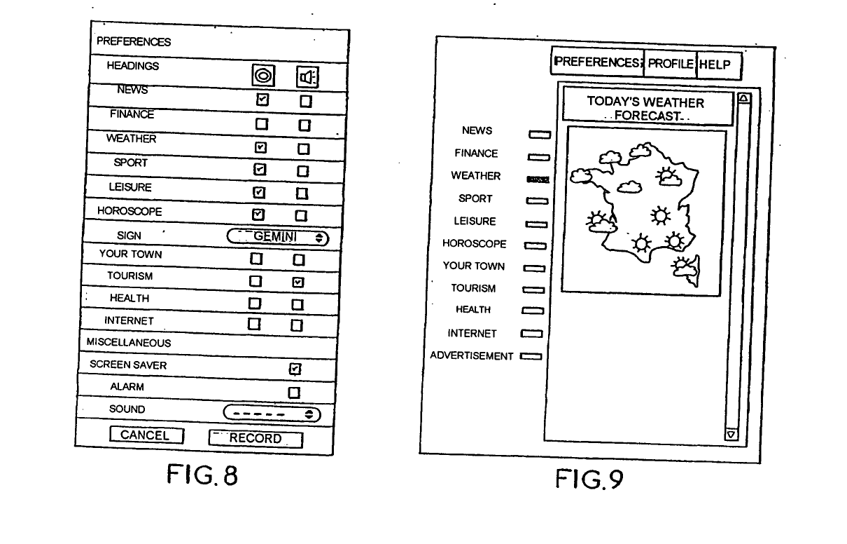

FIG. 8 is an exemplary screen obtained with the receiver connected to the terminal.

FIG. 9, finally, is a diagrammatic representation of a data page received and displayed on the screen of the terminal.

Referring to the drawings, in particular to FIG. 1, depicted therein is the diagram of a system for broadcasting data to intelligent terminals T1, T2, T3. For the requirements of the drawing, the number of terminals has been limited to three, but the broadcasting system imposes no limit as to the number of terminals which can receive the broadcast data. There can be very many of them, depending on the total number installed.

Each intelligent terminal T1, T2, T3 comprises memory means, data processing means, means of connection in respect of peripherals, and a display screen E1, E2, E3 which experiences standby periods, while the terminal is in reduced activity.

The terminals T1, T2, T3 advantageously consist of microcomputers, in particular of the PC or portable type. They can also consist of terminals less powerful than a microcomputer, such as public Internet outlets which allow connection to the Internet network.

Each terminal is equipped with an FM receiver, designated by the letter K, designed to capture data dispatched on an FM (frequency modulation) radio subcarrier SP3 (FIG. 4).

The schematic of FIG. 4 diagrammatically illustrates an FM radio transmission, the frequency being plotted along the abscissa and the amplitude expressed as a percentage, being plotted along the ordinate. The transmission comprises a signal M which corresponds to the two channels: L+R (left+right) of the L.F. stereophonic modulation between 30 Hz and 15 kHz and a multiplex signal MP superimposed on a 38 kHz subcarrier, suppressed on transmission. The signal MP corresponds to a L−R (left minus right) modulation likewise between 30 Hz and 15 kHz so that it extends from 23 to 53 kHz. A subcarrier SP1 at 19 kHz, the stereo pilot frequency, is dispatched; it is situated between the signal M and the multiplex signal MP.

Other subcarriers are generally dispatched by the FM transmitters, namely a subcarrier SP2 at 57 kHz according to the RDS protocol and a subcarrier SP3 at 76 kHz according to the DARC (DAta Radio Channel) protocol. These protocols constitute a technology for FM subcarrier data transmission, which allows the broadcasting of data in addition to the usual radio transmissions, on an FM radio station.

The receiver K is designed to capture data transmitted on the subcarrier SP3 (DARC protocol).

As can be seen in FIG. 5, the receiver K comprises a connector C linked by a high bit rate, for example 2 Mbits/s, flexible cable 1 at the output of the receiver K, for linking through a peripheral socket of the corresponding terminal, for example T1.

Preferably, the connector C consists of a plug 2 for connection to a USB port of the terminal. The receiver K may then not comprise any power source and it is energized directly via the USB port from the terminal T1.

The data are dispatched in FM by a transmitter 3 (FIG. 1) alongside which is placed an encoder 4 for the subcarrier used, in particular a DARC encoder when the subcarrier SP3 is used. The encoder 4 adds the data to the multiplexed FM signal dispatched by the transmitter 3.

The 76 kHz DARC subcarrier is compatible with the audio transmissions and with the 57 kHz subcarrier SP2. Certain encoders 4 support both the DARC encoding and the RDS encoding corresponding to SP2.

The data to be transmitted originate from a service provider 5 who conveys them, for example via the Internet network 6 (IP network) to a DARC server 7. The server 7 can dispatch the data to the FM transmitter according to various means.

According to the upper part of FIG. 1, the server 7 communicates the data to the encoder 4 and to the transmitter 3 by way of the Internet network 6.

According to the middle part of FIG. 1, a direct cable link 8 is envisaged between the server 7 and the encoder 4a and the transmitter 3a.

According to the last line of FIG. 1, the dispatching of the data originating from the server 7 to the encoder 4b and to the transmitter 3b is performed via satellite radio link 9.

The data are dispatched by the transmitters 3, 3a, 3b at a mean bit rate of 16 kbits/s. The bit rate after vertical and horizontal error correction is on average 10 kbits/s. The data are organized into blocks constituting frames. The information can thus be sent globally to all the receivers K, or else in a segmented manner according to predefined criteria (regional, thematic or personal).

A block diagram of the receiver K is given in FIG. 2. The receiver comprises a part 10 for reception proper, a part 11 for decoding and a part 12 for control and transmission of the data on the USB port.

The reception part 10 comprises a tuner 13, consisting for example of the TEA 5757HL integrated circuit from the Philips company, linked to an antenna 14 which can be telescopic as illustrated in FIG. 5, or consisting of a simple electrical wire. A PLL circuit 15, or phase locking circuit, is linked to the tuner 13. An output 16 of the tuner provides the audio signal corresponding to the FM radio transmission and is linked to two acoustic enclosures 17, 18 corresponding to the left channel and to the right channel in the case of stereo reception. The output 6 need not be used if one does not wish to restore the FM radio transmissions, outside of the data provided on the DARC subcarrier.

An output 19 of the tuner 13 delivers the subcarrier signal SP3 to a DARC decoder 20. The decoder 20 comprises an audio output 21 for signals provided preferably in the MP3 format for utilization by a sound card. Another output 22 of the decoder 20 delivers the alphanumeric and graphical data.

As an exemplary decoder 20, mention may be made of the MSM 9560 circuit from the OKI company.

The part 12, for the control and transmission of the data on the USB port, comprises a microprocessor 23, an input of which is linked to the output 22. Memory means 24 comprising a read-only memory (ROM) and a random-access memory (RAM) are linked to the microprocessor 23; memory means 25 formed by an erasable programmable read-only memory (EEPROM) are also linked to the microprocessor 23. An output 26 of the microprocessor 23 is linked to a USB interface 27. The microprocessor 23 can consist of that marketed under the reference CY7C64113 (CYPRESS).

The data transmitted according to the DARC protocol are organized into physical layers according to the OSI reference model, in particular according to 7 physical layers.

Advantageously, the microprocessor 23 of the receiver K is made to process only the first two physical layers 1 and 2 of the data transmitted. This makes it possible to use a microprocessor 23 of smaller capability and to substantially reduce the price of the receiver K. The higher physical layers 3 to 7 of the data transmitted are processed in the intelligent terminal such as T1 to which the receiver K is linked. To this end, software for managing the peripheral K, stored for example on CD-ROM, is installed in the terminal T1; this software comprises a block 28 (FIG. 7) for managing the USB port and a block 29 (FIG. 7) for having the higher DARC layers 3-7 processed by the PC terminal.

The USB management software installed in the PC microcomputer terminal ensures the storage and the management of the data in the PC, as files and folders, as shown diagrammatically by the block 30.

A processing block 31 is designed to ensure the displaying of the data on the screen of the terminal, in particular when it is on standby.

The printed card 32 of the FM receiver can be seen sketchily represented in FIG. 3. To reduce any parasitic influence of the tuner 13 on the other circuits, the tuner 13 together with its antenna 14 is situated on one side of the card 32, on the left of a fictitious line L, while the decoder 20 and the microprocessor 23 are situated to the right of the line L, and are relatively far from the tuner 13. The audio output of the decoder 20 is linked to a connector 21a. The USB output 27, with five wires, is also represented. The other components of the card, in particular resistors and capacitors, are not represented for simplicity.

The receiver K is compact and can fit into a parallelepipedal casing B (FIG. 5) around 85 mm long, 45 mm wide and 16 mm thick. The weight of the receiver is of the order of 35 g. It can work over the 87-108 MHz frequency slot.

The receiver K is provided with a CD-ROM containing its management software and operating software, with application program for displaying the data on the screen of the terminal when it is on standby.

Installation on the PC microcomputer is automatic, the receiver K being entirely “plug and play”, that is to say that when it has been detected by the microcomputer's operating software, the user just has to follow the installation step by step.

The receiver K can, as appropriate, be equipped with a loudspeaker of reduced dimension, integrated into its casing, powered either via the USB port from the terminal, or via a specific power supply provided in the receiver K.

The receiver K can be designed to receive only certain types of transmissions on the DARC subcarrier corresponding to a user-based segmentation. For example, a group of users who are equipped with receivers K may be the only ones to receive data which are destined especially for them and which, on transmission, have received an addressing corresponding to the capabilities of the receivers K with which the intended users are equipped.

Preferably, the data transmitted on the DARC subcarrier are in the HTML page format. The data transmitted can be designed to make it possible to establish a link with a site on a network so as to obtain more detailed information after connection of the terminal to the network. This network is advantageously the Internet network. The standby screen of the terminal becomes a display panel, in particular an advertising panel, the notices displayed possibly being moving notices. The data transmitted take the form of pages or “flashes”, the supplementary information being obtained after connection to a network and exploration of a site corresponding to the “flash”.

The software for managing the receiver K preferably takes the form of an application under Windows® which is divided into two parts:

the viewer proper which manages and displays the information as soon as it is received;

the screen saver which displays the advertising messages when the computer is placed on standby.

The application also makes it possible to drive the receiver K, to adjust the FM reception and to advise the user when reception is poor or inadequate.

The messages received are architectured around several headings which the user can activate or deactivate as illustrated in FIG. 8. The headings comprise for example: News; Finance; Weather; Sport; Leisure; Horoscope, Sign; Your Town; Tourism; Health; Internet; Miscellaneous; Screen Saver; Alarm; Sound.

Certain headings can be activated or deactivated, both in respect of display and in respect of sound, by checking a box opposite the heading and vertically in line with a pictogram representing either the screen, or a loudspeaker. A box is checked by pointing a finger controlled by a mouse at the box on the screen, and by clicking with the mouse. On the other hand, the user cannot at any time deactivate the reception of advertising announcements.

The user can also personalize the reception of information with or without sound accompaniment, and activate or otherwise the screen saver mode.

The user's preferences can be recorded in an electronic message generally called a “cookie” sent to the server center as soon as the user connects up to the Internet. The server center can thus follow the trends of the user and his choices.

The operating software can be designed also to ask the user to fill in a questionnaire defining his profile, which will be dispatched to the server center during an Internet connection.

FIG. 6 gives the diagram of the structure of the receiver and of the part of the PC terminal which combines with the receiver. The lower block corresponds to the FM receiver with the tuner 13 which outputs a demodulated raw signal MPX according to block 13a. The audio signal is directed by the line 21 to the sound card 33 of the PC.

The demodulated raw signal MPX, including the audio part, is dispatched from the block 13a to the DARC decoder 20 which ignores the audio part and which processes the remaining part of the signal. The decoded signal is provided to the part 12 (FIG. 2) constituting the USB interface.

The output signal from the interface 12 is dispatched, via the USB connection, to a corresponding interface 34 provided in the PC. The outgoing signal from the interface 34 is processed in the block 35 of the PC with the aid of the management software (or driver) specific to the receiver K, installed in the PC. The block 35 ensures the DARC decoding of the higher physical layers, in particular of physical layers 3 and 4, possibly up to 7.

The files emanating from the block 35 are organized and stored on the hard disk of the PC, following block 36. The files are then processed at block 37 by software for decoding the protocol of the receiver K for display on the screen of the PC terminal. The block 38 corresponds to the part of the software managing the man/machine interface and processing the information emanating from the block 37 for its display on the screen.

Information is exchanged between the block 35 (driver) and the receiver 13, as well as between the block 38 and the receiver 13, as shown diagrammatically by arrows.

Having said this, the implementation and the use of the data broadcasting system according to the invention are as follows.

The user, who has for example a PC type microcomputer, connects a receiver K via its plug 2 to a USB socket of his computer.

The user thereafter installs in his computer the software for operating the receiver K delivered for example on a CD-ROM.

The power supply to the receiver K is ensured at the time of connecting the receiver to the USB socket of the computer and an initialization phase takes place. The PC computer is informed of the presence of the receiver K which it identifies. The management software sends a first instruction to the receiver K telling it, for example, to lock onto a specified radio frequency, in particular the transmission frequency of a local FM radio. The management software terminates the decoding of the DARC (levels 3 and 4), extracts the data and writes them to the hard disk while informing the higher stage of the application, corresponding to the man/machine interface and to what the user sees on the screen of the computer.

As already indicated, the receiver can be configured, at the software level, so as to recognize and process only data which are addressed to a segment of users.

For example, the receiver K could be provided upon purchase of a microcomputer. The receiver would be configured so as to receive, as regards advertising messages relating to computers, only those originating from the manufacturer of the purchased microcomputer.

According to another example, the receiver K could be configured according to the profession of the user. Receivers K intended for pharmacists would be configured to be the only ones to allow the reception of certain messages intended for this profession.

It is of course possible to imagine other examples of segmentation which involve on transmission a code allocated to the relevant segment of users and, on reception, a means of decoding making it possible to utilize the coded data intended for this segment of users.

The information corresponding to general headings such as News, Finance, etc., will normally be receivable and processable by the receivers of all the users.

The table of FIG. 8, compiled by the receiver operating software, can be brought up onto the screen by each user so that he can configure his preferences. In the example represented in FIG. 8 the user has chosen to receive messages corresponding to ticked boxes, that is to say: News, Weather, Sport, Leisure and Horoscope with the choice of the star sign “Gemini”; the screen display has alone been chosen for this information, with no sound signal.

For the Tourism heading, sound signaling has been adopted as it has also for the Screen Saver.

By activating the box corresponding to sound accompaniment, the user can be informed by a sound as soon as a “flash” arrives.

On the transmission side (see FIG. 1), the service provider 5 sends HTML files to the DARC server 7, with possible addressing so that these files can be utilized only by a corresponding segment of users. The files are sent to the associated FM transmitter 3, 3a or 3b.

The data are dispatched on the DARC subcarrier multiplexed with the audio transmission of the corresponding transmitter 3, 3a, 3b. On reception, as already indicated, K ignores everything except the signal addressed to it.

Data can be broadcast very fast to a large number of users by FM radio from a transmitter, at a national or regional level.

The data are frequently updated, for example every hour, over a slot which can extend from 7 h to 22 h, in particular with a transmission of a quarter of an hour per hour.

A simplified example of a “flash” page which can be broadcast by FM transmitter is represented in FIG. 9 in respect of weather information. The map of France is reproduced with symbolic indications of the forecasts. This page in HTML format provides for a link with the Internet network, thus allowing the user who wants more complete information to connect up to the Internet site of the corresponding service provider.

Each local transmitter of a town preferably has its coder.

The access system can be made secure by incorporating into the receiver K a modem which is linked to the switched telephone network. The FM transmission pertains to an encrypted message with simultaneous sending on the switched telephone network of a supplement to this message allowing its decryption.

Only the receiver which receives these two supplementary messages will be able to utilize the data transmitted by FM.

Conversely, the recognizing of a user or of a customer could be achieved by combining the references of his receiver K and for example a bank card number dispatched via the switched network.

With the system of the invention, a PC computer becomes a kind of FM receiver when the screen is in standby mode, this screen becoming a display panel for various messages, in particular advertising messages.

This information is updated at lower cost. The information is received by the users without them having to connect up to a network such as the Internet. It is also possible, without connection to the Internet network, to record musical information in the MP3 form.

Although energization from the terminal via the USB port is very advantageous, it is of course possible to envisage a power supply in the receiver K which is then self-energized so as to operate with terminals other than a PC, comprising no USB port.

1. A system for broadcasting periodically updated data to intelligent terminals (T1, T2, T3) comprising memory means, data processing means, means of connection with peripherals, and a display screen (E1, E2, E3) which can be placed on standby automatically in the course of periods of reduced activity of the associated terminal which remains powered up, characterized in that it comprises, for each terminal, an FM receiver (K) designed to capture data transmitted on an FM radio transmitter subcarrier (SP3), this receiver (K) comprising a connector (C) for linking to a peripheral socket of the terminal, and in that software is installed in the terminal (T1, T2, T3) for utilizing the data captured by the receiver (K), the assembly being designed to ensure the displaying of the captured data on the screen when it is on standby, these data moreover being stored in memory means of the terminal and being retrievable for display.

2. The system as claimed in claim 1, characterized in that it comprises a server (7) which dispatches data originating from a provider to the FM transmitter (3).

3. The system as claimed in claim 1 or 2, characterized in that the subcarrier (SP3) used is the 76 kHz DARC subcarrier.

4. The system as claimed in claim 3, characterized in that, for the dispatching of the data, a DARC encoder (4, 4a, 4b) is placed alongside the FM transmitter (3, 3a, 3b) for adding the data to the multiplexed FM signal.

5. The system as claimed in one of the preceding claims, characterized in that each intelligent terminal (T1, T2, T3) is a microcomputer, in particular of PC or portable type.

6. The system as claimed in one of the preceding claims, characterized in that the broadcast data are encrypted in such as way as to be utilizable only by an FM receiver (K) comprising the decryption key.

7. The system as claimed in one of the preceding claims, characterized in that the data dispatched by FM channel are designed to make it possible to establish a link with a site on a cabled network in respect of more detailed information concerning the data broadcast, access to the site being ensured by connection of the terminal to the network.

8. The system as claimed in claim 7, characterized in that the network is the Internet network.

9. The system as claimed in one of the preceding claims, characterized in that the data are dispatched in the form of pages in the HTML format.

10. The system as claimed in one of the preceding claims, characterized in that the means of connection of the FM receiver (K) to the terminal consists of a plug (2) for USB socket of the terminal.

11. The system as claimed in claim 10, characterized in that the powering up of the FM receiver (K) is ensured by the USB socket from the terminal (T1, T2, T3).

12. The system as claimed in one of the preceding claims, characterized in that the FM receiver (K) comprises processing means (23) having limited capability for performing only a part of the processing of the data received, and the other part of the processing of the data is ensured by the intelligent terminal (T1, T2, T3) in which software for operating the receiver has been installed.

13. The system as claimed in claim 12, characterized in that in the case of broadcasting on DARC subcarrier (SP3), the FM receiver (K) performs the processing corresponding to the first two physical layers alone, while the intelligent terminal (T1, T2, T3) performs the processing corresponding to the subsequent physical layers.

14. An FM receiver for data broadcasting system according to one of the preceding claims, characterized in that it is designed to capture data transmitted on an FM radio transmitter subcarrier (SP3), in that it comprises a plug (2) for linking to a peripheral socket of an intelligent terminal (T1, T2, T3) and in that it is combined with software designed to be installed in the terminal for utilizing the data captured by the receiver (K) and for ensuring the displaying of the captured data on the screen of the terminal when it is on standby.

15. The FM receiver as claimed in claim 14, characterized in that the plug (2) is designed for connection to a USB socket of the terminal.

16. The FM receiver as claimed in claim 14 or 15 for data dispatched on DARC subcarrier, characterized in that the receiver (K) is designed to process only the first two physical layers.

17. The FM receiver as claimed in one of claims 14 to 16, characterized in that it comprises a part (10) for reception proper, a part (11) for decoding and a part (12) for control and transmission of the data on the USB port.

18. The FM receiver as claimed in claim 17, characterized in that the reception part (10) comprises a tuner (13) linked to an antenna (14) with a PLL circuit (15) linked to the tuner (13), that an output (19) of the tuner delivers the subcarrier signal to the part (11) which comprises a DARC decoder (20) with an audio output (21) and another output (22) which delivers alphanumeric and graphical data to the part (12), which comprises a microprocessor (23), memory means (24) linked to the microprocessor (23) as well as an erasable programmable read-only memory (25) (EEPROM), an output (26) of the microprocessor (23) being linked to a USB interface (27).

19. The FM receiver as claimed in claims 16 and 18 together, characterized in that the microprocessor (23) of the receiver (K) processes only the first two physical layers of the data dispatched.
